(19) United States
(12) Patent Application Publication
(10) Pub. No.: US 2007/0027752 A1
(43) Pub. Date: Feb. 1, 2007

(54) Presentation of network-accessible marketable information within a web page

(75) Inventor: David Haslam, Atlanta, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/315,759

(22) Filed: Dec. 19, 2005

Related U.S. Application Data
(60) Provisional application No. 60/703,648, filed on Jul. 29, 2005.

(51) Int. Cl. G06Q 99/00; G07G 1/14; G06Q 30/00

(52) U.S. Cl. 705/14; 705/1

(57) ABSTRACT

Disclosed herein is a device, method, and system for presenting marketable information stored in a database of a remote server. The remote server provides a web page via a network. The web page includes a module that scrolls marketable information from a database where the marketable information corresponds to an identity of the use requesting the web page. The system includes a subscriber computing device that receives a web page via the network. The subscriber computing device includes a display device that displays the web page along with the scrolling marketable information in the module. The subscriber computing device can provide a request and information to purchase an item associated with the marketable information that was presented by the module in the web page. The remote server can process the request and information to purchase an item corresponding to the marketable information requested by the subscriber computing device.

### RELATED APPLICATIONS

The present application claims priority to U.S. Provisional Application 60/703,648, filed on Jul. 29, 2005, and entitled MODULE FOR PRESENTATION OF NETWORK-ACCESSIBLE PHOTOGRAPHS OR OTHER CONTENT WITHIN A WEB PAGE.

### BACKGROUND

Before the digital age, photographs were taken with cameras using photographic film, which was provided to a processing center that printed the photographs on the film on photographic paper. With the development of digital cameras, photographs can be printed from a home purchased printer and/or downloaded onto a personal computer. The photographs can also be posted on the Internet, such as in the web sites of the Ofoto® service, the Snapfish® service, or the Shutterfly® service (all of which are photo companies), so that others can view and print the photographs from the web sites. These Internet-photograph companies specialize in downloading the photographs into a database and enabling others to share the database in order to view and/or print the photographs. The photograph companies enable a user to select a photograph from the database and print the photograph at a particular cost.

The photographs can be sorted in photo albums that the user can create. For example, assume a user took several photographs from a trip to Las Vegas. The user can download and sort the photographs in a photo album called Las Vegas 2005. However, the user can view the photographs in the photo album only if the user accesses the photo album. From a marketing perspective, this is not ideal because the user cannot easily obtain the photographs unless the user “opens” the photo album. In addition, the photographs are not recurrently and automatically shown to the user. The Internet-photograph companies would like the user to see different pictures in the photo album whenever the user is on the web sites of the Internet-photograph companies or other web sites. Exposing the user to more photographs may make the user more prone to buy a print of the photograph from the Internet-photograph companies.

Thus, a heretofore unaddressed need exists in the industry to address the aforementioned deficiencies and inadequacies.

### SUMMARY

Embodiments of the present disclosure provide devices, systems, and methods for presenting identifications of marketable information stored in a database of a remote server. The remote server provides a web page via a network. The web page includes a module that scrolls marketable information from a database. The system includes a subscriber computing device that receives a web page via the network. The subscriber computing device displays the web page along with the scrolling marketable information in the module. The subscriber computing device can provide a request and information to purchase an item associated with the marketable information that was presented by the module in the web page. The remote server can process the request and information to purchase the item associated with the marketable information that has been requested by the subscriber computing device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is systematic view of an embodiment of a system from which a plurality of photographs can be presented via a network.

FIG. 2 is a block diagram of an embodiment of a subscriber computing device shown in FIG. 1.

FIG. 3 is an illustration of a display associated with a photo company web page according to one embodiment.

FIG. 4 is an illustration of a display associated with a provider home web page according to one embodiment.

FIG. 5 is a block diagram of an embodiment of a photo storage application server shown in FIG. 1.

FIG. 6 is a block diagram of an embodiment of a network provider server shown in FIG. 1.

FIG. 7 is a flow diagram that illustrates an embodiment of an operation of a system shown in FIG. 1 in presenting marketable information via the network.

FIG. 8 is a flow diagram that illustrates an embodiment of an operation of a system shown in FIG. 1 in presenting the plurality of photographs via the network.

FIG. 9 is a flow diagram that illustrates an embodiment of operation of a subscriber network manager of the subscriber computing device shown in FIG. 2.

FIG. 10 is a flow diagram that illustrates an embodiment of operation of a photo server manager of the photo storage application server shown in FIG. 5.

FIG. 11 is a flow diagram that illustrates an embodiment of operation of a network provider manager of the network provider server shown in FIG. 6.

FIGS. 12A-C show a sequence of screen captures of a module of a web page that scrolls photographs and provides controls to the user for the scrolling photos according to one embodiment.

### DETAILED DESCRIPTION OF THE DISCLOSURE

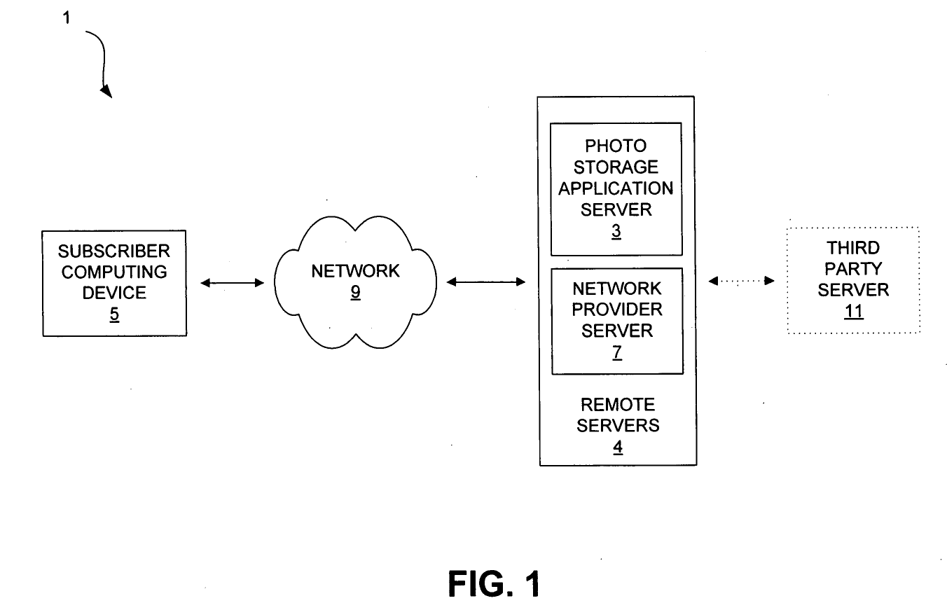

Referring now in more detail to the figures in which like reference numerals identify corresponding parts, FIG. 1 illustrates an example system 1 that presents an identification of marketable information stored in a database of a remote server 4. As indicated in this figure, the system 1 generally comprises a subscriber computing device 5, network 9, remote server(s) 4, and third party server 11. The remote servers (4) can include, but are not limited to, a photo storage application server 3 and a network provider server 7. Although FIG. 1 shows one photo storage application server 3, one subscriber computing device 5, one network provider server 7, and one third party server 11, it should be appreciated that there may be multiple photo storage application servers 3, multiple subscriber computing devices 5, multiple network provider servers 7, and multiple third party servers 11.

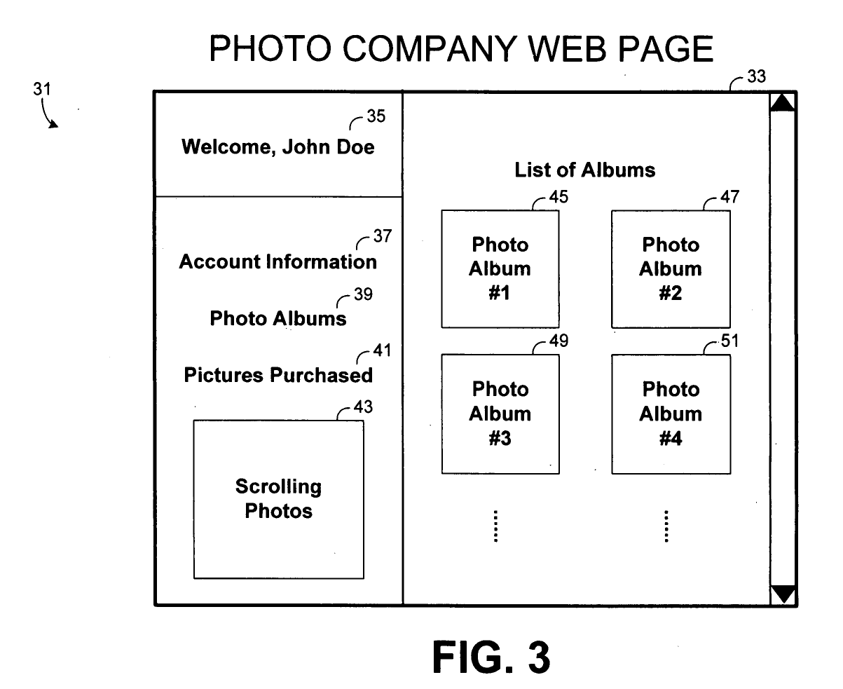

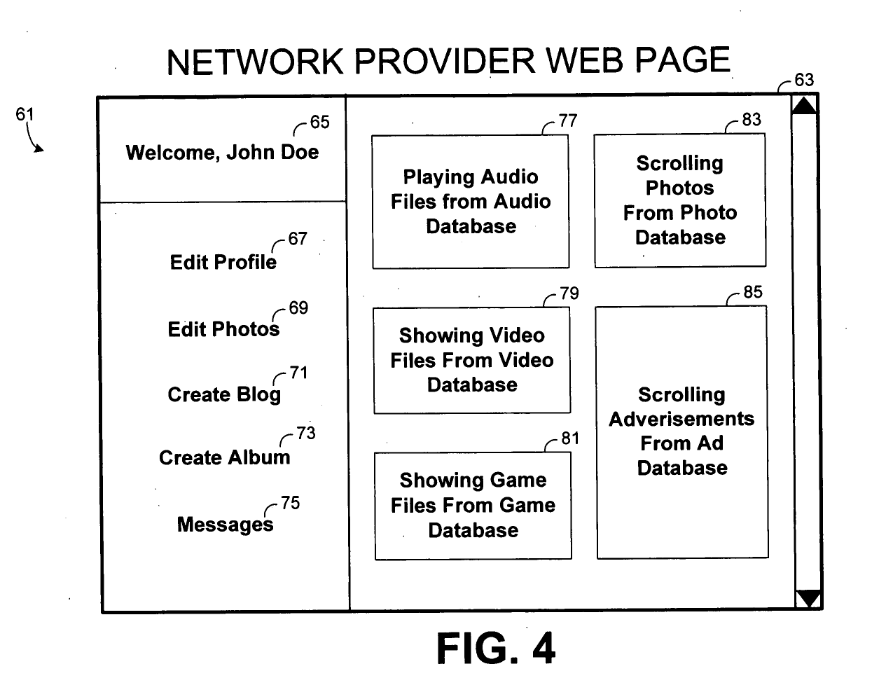

According to one embodiment, the subscriber computing device 5 establishes connection to the network 9 via the network provider server 7, which enables the subscriber computing device 5 to communicate through the network 9. Some network providers that have a network provider server 7 include the BellSouth® network, the Comcast® network, etc. When the subscriber computing device 5 accesses the network 9, the network provider server 7 provides a web site of the network provider to the subscriber computing device 5, which is shown and described in relation to FIG. 4. Through the network 9, the subscriber computing device 5 can access a web page from an application server such as the photo storage application server 3 to download and view marketable information such as photographs from a database stored on the photo storage application server 3, which is shown and described in relation to FIG. 3. Some photograph companies that have a photo storage application server 3 are the Ofoto® service, the Snapfish® service, the Shutterfly® service, etc.

The photo storage application server 3 and/or the network provider server 7 can also obtain photographs along with other types of marketable information from a third party server 11 as shown in FIG. 1. The other types of marketable information can include, but are not limited to, advertisements, audio files, video files, and on-line game clips. In one example, a web page from either the photo storage application server 3 or the network provider server 7, or both, includes an identification of the marketable information provided by the third party server 11. The identification of the marketable information can be provided to the subscriber computing device 5 such that a subscriber can be exposed to marketable information and is prone to purchase the marketed products, such as a CD for the audio files, a DVD from the video files, a game cartridge from the on-line game clips, etc. In an alternative embodiment, the photo storage application server 3 and/or the network provider server 7 can obtain the marketable information from the third party server 11 through the network 9. The identification of the marketable information can be a link that directs the subscriber to another web page that provides more information on the marketable information and provides instructions for the subscriber to purchase the marketed product of the marketable information.

The marketable information, particularly photographs, is in correspondence with the identity of the user of the subscriber computing device 5. For example, the subscriber computing device may be prompted to enter a user identifier by the web page or the subscriber computing device may automatically provide the identity such as where a cookie is included on the subscriber computing device to identity the user. Accordingly, the proper marketable information may be provided via the module of the web page, such as photographs of a photo album of the user where the user or someone else has uploaded photographs to the user's photo album.

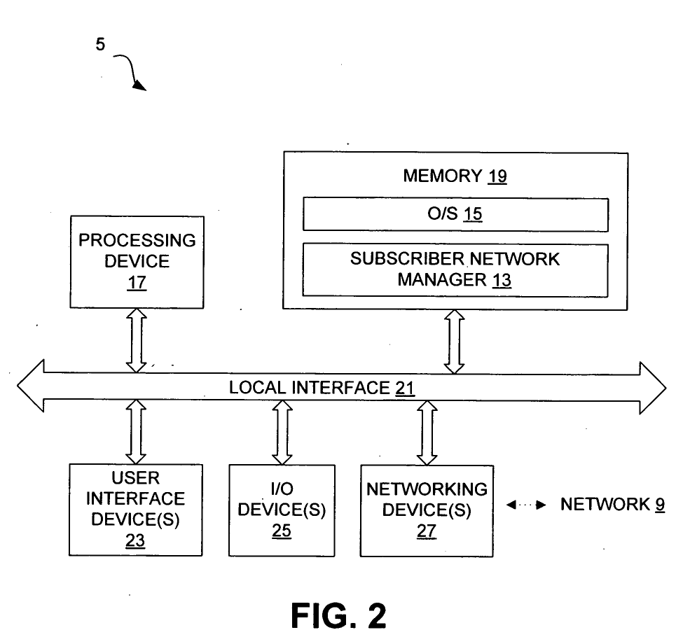

FIG. 2 is a block diagram illustrating an exemplary architecture for the subscriber computing device 5 shown in FIG. 1. As indicated in FIG. 2, the subscriber computing device 5 comprises a processing device 17, memory 19, one or more user interface devices 23, one or more I/O devices 25, and one or more networking devices 27, each of which is connected to a local interface 21. The processing device 17 can include any custom made or commercially available processor, a central processing unit (CPU) or an auxiliary processor among several processors associated with the subscriber computing device 5, a semi-conductor base microprocessor (in the form of a microchip) or a macroprocessor. The memory 19 can include any one or a combination of memory elements (e.g., random access memory (RAM, such as DRAM, SRAM, etc.)) and nonvolatile memory elements (e.g., ROM, hard drive, tape, CDROM, etc.).

The one or more user interface devices 23 comprise those components with which the subscriber can interact with the subscriber computing device 5. Where the subscriber computing device 5 comprises a desktop computer, laptop computer, or similar device, these components can comprise those typically used in conjunction with a PC, such as a display device, keyboard and mouse.

The one or more I/O devices 25 comprise components used to facilitate connection of the subscriber computing device 5 to other devices and therefore, for instance, comprise one or more serial, parallel, small system interface (SCSI), universal serial bus (USB), or IEEE 1394 (e.g., Firewire™) connection elements. The networking devices 27 comprise the various components used to transmit and/or receive data over the network 9, where provided. By way of example, the networking devices 27 include a device that can communicate both inputs and outputs, for instance, a modulator/demodulator (e.g., modem), a radio frequency (RF) or infrared (IR) transceiver, a telephonic interface, a bridge, a router, as well as a network card, etc.

The memory 19 normally comprises various programs (in software and/or firmware) including an operating system (O/S) 15 and a subscriber network manager 13. The O/S 15 controls the execution of programs, including the subscriber network manager 13. The O/S 15 also provides scheduling, input-output control, file and data management, memory management, and communication control and related services. The subscriber network manager 13 facilitates the process for exposing a subscriber to marketable information, particularly photographs, so that the subscriber is prone to purchase marketed products, such as photographic prints.

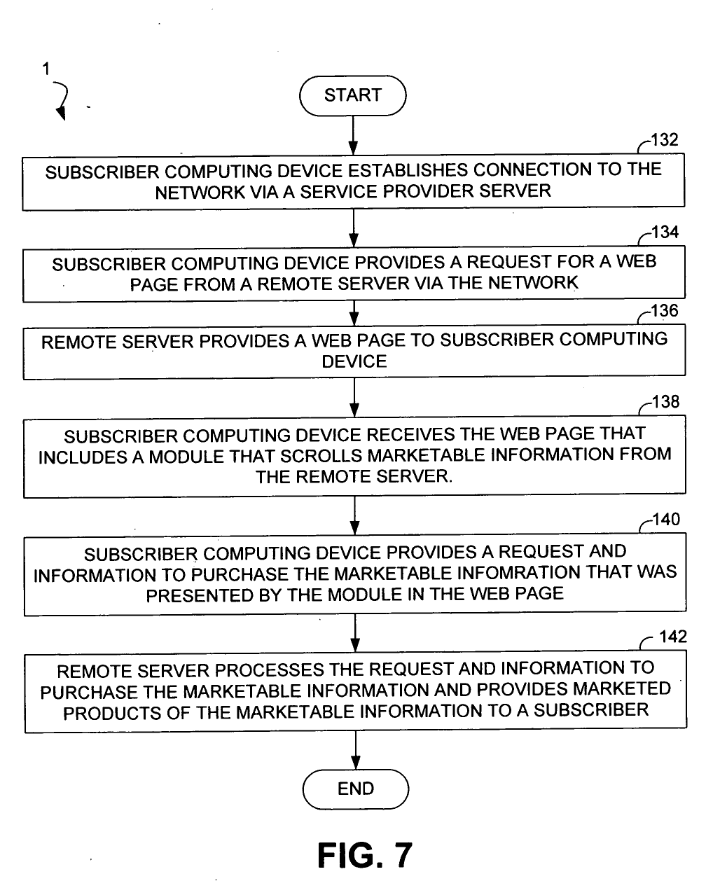

According to an exemplary embodiment, the subscriber network manager 13 facilitates communication between the subscriber computing device 5 and remote servers 4 via the network 9. The subscriber computing device 5 accesses web pages from remote servers 4 via the network 9 and the web pages include marketable information that are presented to the subscriber in such a way that makes the subscriber prone to purchasing the marketed products. Operation of the subscriber network manager 13 is described in relation to FIGS. 7, 8, and 9.

FIG. 3 is an exemplary display of a web page from a photo storage application server 3. The web page 31 is displayed when a subscriber registers with the photo storage application server 3 via the network 9. In one embodiment, the registration requires a login name and a password, and may further require residential address and credit card information if the subscriber requests to purchase a photograph. After the subscriber is registered, the photo storage application server 3 can provide a web page that the subscriber can personalize. The web page 31 includes links for obtaining information on the account 37, accessing photo albums 39, and accessing purchased pictures 41. The web page further includes a module 43 that scrolls a plurality of photographs stored in a database of the photo storage application server 3. The module 43 can present multiple photographs from the database at a particular time interval, such as every 3 seconds, 5 seconds, and day, etc., and/or at each log-in event.

In this embodiment of the web page 31, the subscriber accessed the photo albums and so the web page 31 displays a list of albums that include photo album #1 45, photo album #2 47, photo album #3 49, and photo album #4 51. The subscriber has the capability to arrange and move the photographs in each album to another album. The photo albums can be renamed so that they may remind the subscriber of the photographs contained in the album. Thus, the subscriber can name the albums with various names, including but not limited to, my favorites, summer camp 2005, France 2004, and family reunion 2003, etc.

FIG. 4 is an exemplary display of a network provider web page. The web page 61 can be displayed when the subscriber establishes connection to the network 9 through the network provider server 7. For example, after the subscriber computing device 5 connects to the network 9 through the network provider server 7, a web page can appear on the user interface device 23 of the subscriber computing device 5 that is provided by the network provider server 7. In another example, after the connection is established between the subscriber computing device 5 and the network 9, the network provider server can provide a web page for the subscriber so that the subscriber can personalize the web site. The subscriber accesses the subscriber's personalized web page provided by the network provider server 7, and the subscriber can post pictures, wedding information, personal diaries, blog, etc.

In both examples, the web page 61 can provide links for editing the subscriber's profile 67, editing photographs 69, creating a blog 71, creating albums 73, and accessing, sending, or delivering messages 75. The network provider web page 61 has the capability of providing marketable information to the subscriber that includes, but are not limited to, playing multiple audio files from an audio database 77, showing multiple video files from a video database 79, showing multiple game files from a game database 81, scrolling multiple photographs from a photograph database 83, and scrolling advertisements from an advertisement database 85.

In this embodiment, the module for scrolling photo albums 83 can be processed through the photo storage application server 3. The other modules for playing audio 77, showing video files 79, showing game files 81, and scrolling advertisements 85 can be accessed and/or presented by a third party server 11. It should be noted that the modules 77, 79, 81, 83, and 85 can also be displayed or presented in the photo company web page. The modules 77, 79, 81, 83, and 85 present identifications of the marketable information and can provide their respective multiple marketable information to the subscriber at a particular time interval, such as every 3 seconds, 5 seconds, and day, etc., and/or at each log-in event.

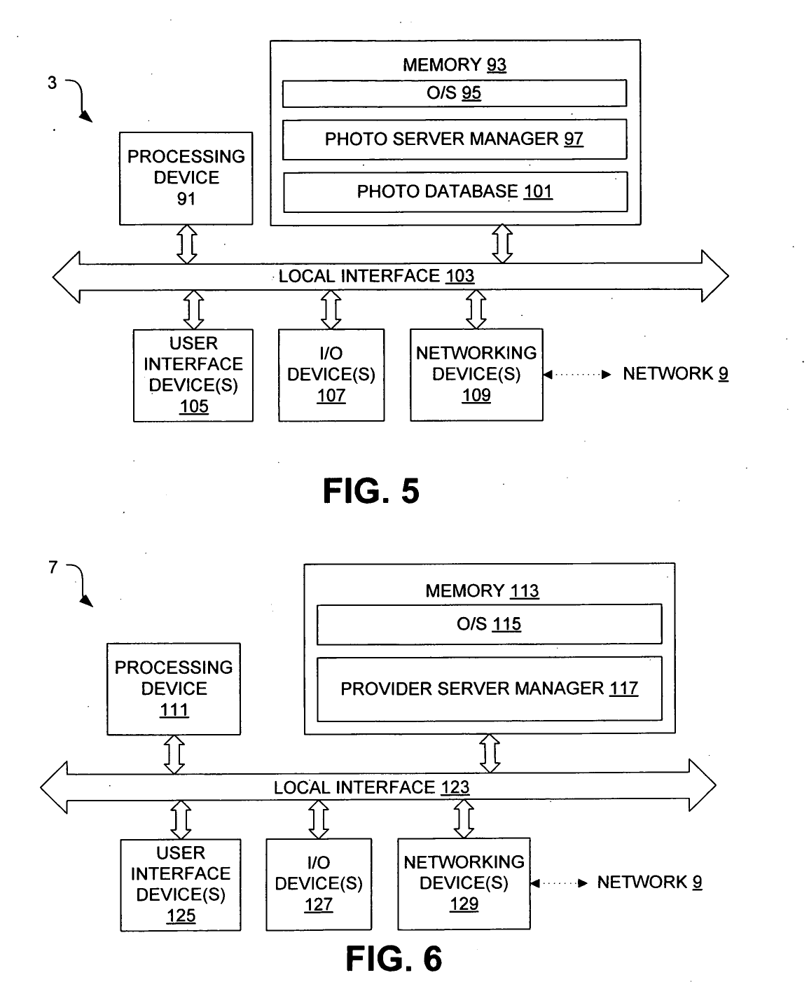

FIG. 5 is a block diagram of an embodiment of a photo storage application server shown in FIG. 1. The architecture for the photo storage application server 3 is similar to the architecture of the subscriber computing device 5 described above and therefore includes a processing device 91, one or more user interface devices 105, one or more I/O devices 107, and one or more networking devices 109, each of which is connected to a local interface 103.

The memory 93 in the photo storage application server 3 includes, among other elements, a photo server manager 97 and photo database 101 that facilitates exposing photographs to a subscriber so that the subscriber is prone to purchase a photographic print of a photograph. According to an exemplary embodiment, the photo server manager 97 communicates with a subscriber computing device 5 via the network 9 to provide multiple photographs to the subscriber computing device 5. More particularly, the photo server manager 97 provides to the subscriber computing device 5 a module on the web page of the photo company that scrolls the photographs stored in the database of the photo storage application server 3. The module can scroll the photographs similar to a slideshow of Microsoft PowerPoint® so that the subscriber is exposed to multiple photographs, and the subscriber is prone to purchase photographic prints of the photographs from the photo company.

FIG. 6 is a block diagram of an embodiment of a network provider server shown in FIG. 1. The architecture for the network provider server 7 is similar to the architecture of the subscriber computing device 5 described above and therefore includes a processing device 111, one or more user interface devices 125, one or more I/O devices 127, and one or more networking devices 129, each of which is connected to a local interface 123.

The memory 113 in the network provider server 7 includes, among other elements, a provider network manager 117 that facilitates exposing marketable information to a subscriber so that the subscriber is prone to purchase marketed products of the marketable information. According to an exemplary embodiment, the provider network manager 117 communicates with a subscriber computing device 5 via the network 9 to provide multiple photographs to the subscriber computing device 5. More particularly, the provider network manager 117 facilitates establishing communication between the subscriber computing device 5 and the photo storage application server 3. The subscriber computing device 5 can receive a web page of the network provider server 7 that includes a module that scrolls multiple photographs from the photo storage application server 3. As mentioned above, the module can include a slideshow of the photographs that exposes the subscriber to multiple photographs so that the subscriber is prone to purchase photographic prints of the photographs from the photo company.

It should be appreciated that the architecture for a third party server 11 is similar to the architecture of the photo storage application server 3 described above and therefore includes a processing device, one or more user interface devices, one or more I/O devices, and one or more networking devices, each of which is connected to a local interface.

The memory in the third party server 11 includes, among other elements, a marketable information manager and marketable information database that facilitates exposing marketable information, such as, among others, audio files, video files, and on-line game clips to a subscriber so that the subscriber is prone to purchase marketed products, such as, among others, CDs, wave files, and MP3s for the audio files, DVDs from the video files, and game cartridges from the on-line game clips. According to an exemplary embodiment, the marketable information manager communicates with a subscriber computing device 5 via the network 9 to provide marketable information to the subscriber computing device 5. More particularly, the marketable information manager provides to the subscriber computing device 5 a module on a web page of either the photo company or network provider, or both, that scrolls the marketable information stored in the database of the third party server 11. The module that scrolls marketable information exposes the subscriber to the marketable information so that subscriber is prone to purchase the marketed products from the third party server 11.

Various programs have been described above. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussions that follow, flow diagrams are provided. Any process steps or blocks in these flow diagrams may represent modules, segments, or portions of code, preferably stored and/or communicated on recordable medium as logic, that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 7 is a flow diagram that illustrates an embodiment of an operation of a system shown in FIG. 1 in presenting marketable information via a network. As mentioned above, marketable information includes, but is not limited, photographs, advertisements, audio files, video files, and on-line game clips. With the system 1, a subscriber can be presented and exposed to marketable information through the subscriber computing device 5 that communicates to a remote server 4 and/or a third party server 11 via a network 9.

Beginning with block 132, the system 1 for presenting the marketable information via the network 9 includes a subscriber computing device 5 that establishes connection to the network 9 via a network provider server 7. The subscriber computing device 5 can communicate an IP address that was assigned to the subscriber computing device 5 by the network provider server 7. The subscriber computing device 5 can be assigned a temporary internet protocol (IP) address for the duration if a dial-in session is being established. The subscriber computing device 5 can be a permanent IP address or it might obtain a temporary one from a DHCP (Dynamic Host Configuration Protocol) server if the subscriber computing device 5 connects to the network 9 from a local area network (LAN) (not shown). In any case, if the subscriber computing device 5 is connected to the network 9, the subscriber computing device 5 has a unique IP address.

In block 134, the subscriber computing device 5 provides a request for a web page from a remote server 4 via the network 9. In block 136, the remote server 4 provides a web page to the subscriber computing device 5. In block 138, the subscriber computing device 5 receives the web page that includes a module that presents and scrolls the marketable information from a database of the remote server 4. In block 140, the subscriber computing device 5 provides a request and information to purchase the marketable information that was presented by the module in the web page. For example, the module can include a link corresponding to the respective marketable information that a subscriber can click on the link to request for more information. Responsive to the request, the subscriber can be presented with another web page that provides instructions for purchasing a marketed product based on the marketable information. The subscriber may be instructed to provide credit card information, residential address, phone numbers, employer's name and address, etc. In block 142, the remote server 4 processes the request and information to purchase the marketed product based on the marketable information from the subscriber computing device 5 and provides the marketed product to the subscriber.

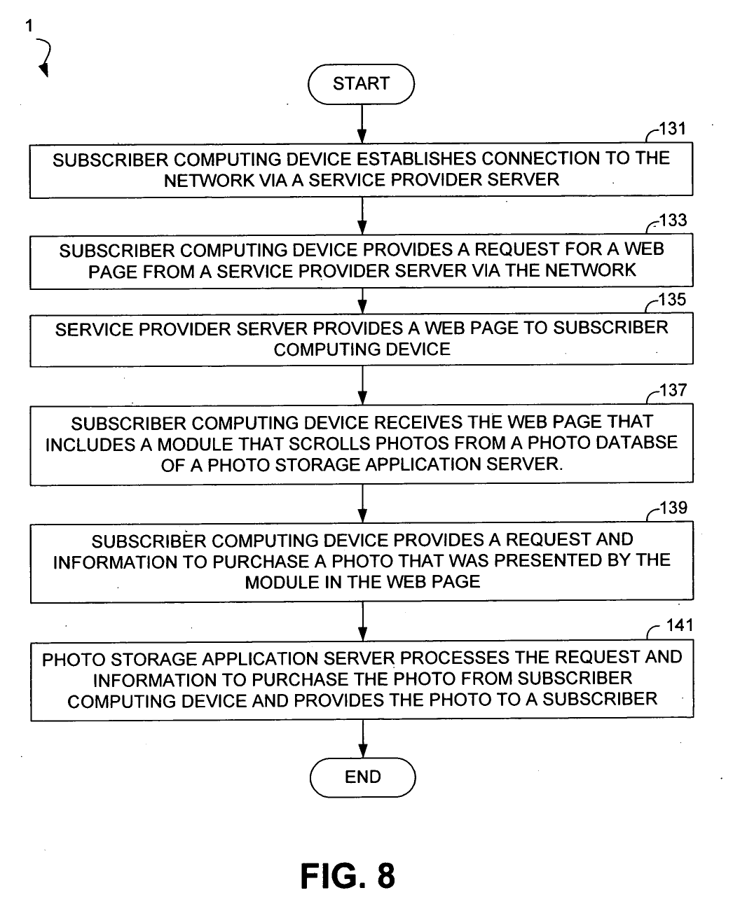

FIG. 8 is a flow diagram that illustrates an embodiment of an operation of a system shown in FIG. 1 in presenting the plurality of photographs via a network. With the system 1, a subscriber can be presented and exposed to multiple photographs through the subscriber computing device 5 that communicates to a photo storage application server 3 via a network 9. It should be understood that other marketable information such as audio files 77, video files 79, game files 81, and advertisements 85 can be accessed and/or presented by a third party server 11 through the photo company web page and/or network provider web page.

Beginning with block 131, the system 1 for presenting the plurality of photographs via the network 9 includes a subscriber computing device 5 that establishes connection to the network 9 via a network provider server 7. In block 133, the subscriber computing device 5 provides a request for a web page from a photo storage application server 3 via the network 9. In block 135, the photo storage application server 3 provides a web page to the subscriber computing device 5. It should be appreciated that a web page from the network provider server 7 can be provided to the subscriber computing device 5 upon connection to the network 9.

In block 137, the subscriber computing device 5 receives the web page from either the photo storage application server 3 or network provider server 7, or both, that includes a module that scrolls and presents multiple photographs from a photo storage application server 3. The module can scroll the photographs in a slideshow that is similar to the slideshow presented by Microsoft PowerPoint®. In block 139, the subscriber computing device 5 provides a request and information to purchase a photograph that was presented by the module in the web page. For example, the subscriber sees a particular photograph that is of interest and clicks on the photograph, which directs the subscriber to another web page. The web page can provide an expanded view of the photograph and include instructions for purchasing a photographic print of the photograph. In block 141, the photo storage application server 3 processes the request and information to purchase the photograph from the subscriber computing device 5 and provides the photographic print of the photograph to the subscriber.

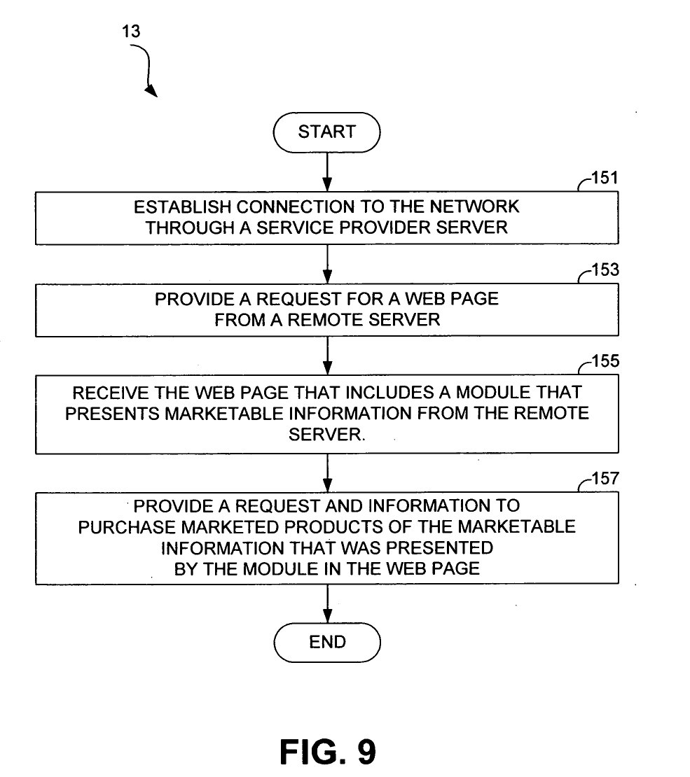

FIG. 9 is a flow diagram that illustrates an embodiment of operation of a subscriber network manager shown in FIG. 2. The subscriber network manager 13, as indicated in block 151, establishes a connection to the network 9 through a network provider server 7. In block 153, the subscriber network manager 13 provides a request for a web page from a remote server 4 and in block 155, receives a web page that includes a module that scrolls and presents marketable information from a remote server 4. The web page can be received from remote servers 4 of photo companies and/or network providers.

In block 157, the subscriber network manager 13 provides a request and information to purchase a marketed product based on the marketable information that was presented by the module in the web page. For example, when a subscriber sees a photograph on the module that he would like to purchase, the subscriber clicks on the photograph and another web page appears on the subscriber computing device 5 to provide an expanded version of the photograph. The web page contains options that the subscriber can select to purchase the photograph such as a link entitled, “purchase photo.” When the subscriber selects the option to purchase the photograph, another web page appears requesting purchasing information, such as the subscriber's name, address, method of payment, credit card information, etc. The subscriber provides the purchasing information to the subscriber computing device 5, which transmits the purchasing information to the photo storage application server 3 for printing the selected photograph from the module.

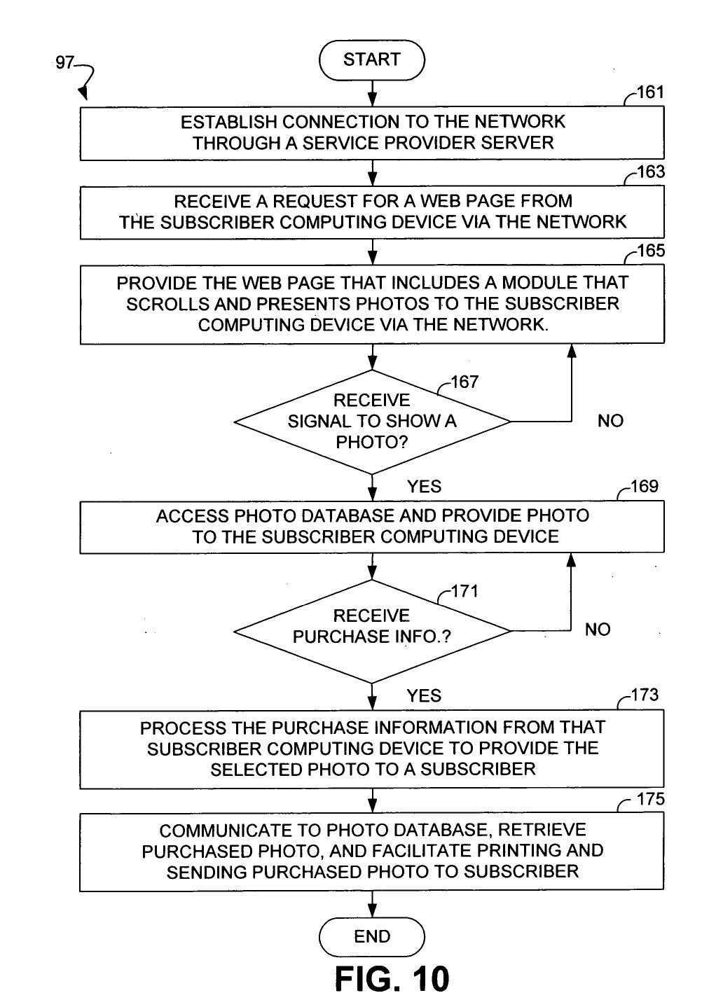

FIG. 10 is a flow diagram that illustrates an embodiment of operation of a photo server manager of the photo storage application server shown in FIG. 5. The photo server manager 97 establishes, as indicated in block 161, a connection to the network 9 through a network provider server 7. In block 163, the photo server manager 97 receives a request from a subscriber computing device 5 via the network 9 and in block 165, provides the subscriber computing device 5 the web page from the photo storage application server 3 that includes a module that scrolls and presents photographs in a slideshow via the network 9. The photo server manager 97 communicates to the photo database 101 to retrieve the multiple photographs and provides the photographs in a slideshow on the module to the subscriber computing device 5. As mentioned above, it should be appreciated that the photo server manager 97 can provide the module to another server's web page, e.g., network provider server 7.

In block 167, the photo server manager 97 determines whether a subscriber selected a photograph on the module. If a photograph was not selected, the module continues to scroll and present the photographs on the web page. If a photograph was selected, the photo server manager 97, as indicated in block 169, accesses the selected photograph from a photo database 101 and provides the selected photograph to the subscriber computing device 5, preferably in a high resolution.

In block 171, the photo server manager 97 determines whether the subscriber requested and provided information to purchase the photograph. If the photo server manager 97 does not receive the purchase request and information, the photo server manager 97 continues to present the selected photograph in high resolution. If the purchase request and information was received, the photo server manager 97 processes, as indicated in block 173, the purchase request and information from the subscriber computing device 5 to provide a photographic print of the selected photograph to the subscriber. In block 175, the photo server manager 97 communicates to the photo database 101, retrieves the selected photograph, and facilitates printing and sending the purchased photograph to the subscriber.

It should be appreciated that the third party server 11 includes a third party manager that is similar to the photo server manager 97. The third party manager essentially performs the same steps of the photo server manager 97 as described above in relation to FIG. 9 but with respect to audio files, video files, on-line game clips and advertisements. The third party manager provides a module that scrolls and presents, for example, audio files on a web page from any remote servers 4, such as the photo storage application server 3 and/or network provider server 7.

The third party manager communicates to an audio database to retrieve the audio files and provides the audio files to the subscriber computing device 5. The module scrolls the audio files by playing the audio files at certain time intervals. For example, a first audio file plays for 10 seconds and then a second audio file plays for the next 10 seconds and so on and so on. While the audio files are playing, an identification that represents the respective audio file is displayed by the module on the web page. The subscriber can click on the identification and link to another web page to obtain more information about the selected audio file.

The third party manager determines whether a subscriber selected an audio file on the module. If an audio file was not selected, the module continues to scroll and present the audio files on the web page. If an audio file was selected, the third party manager accesses the selected audio file from an audio database and provides the selected audio file to the subscriber computing device 5, preferably in a better quality version. The third party manager determines whether the subscriber requested and provided information to purchase the audio file. If the third party manager does not receive the purchase request and information, the third party manager continues to play the selected audio file. If the purchase request and information was received, the third party manager processes the purchase request and information from the subscriber computing device 5 to provide a CD or wave file or MP3 file of the selected audio file to the subscriber. The third party manager communicates to the audio database, retrieves the selected audio file, and facilitates creating a CD or transmitting the wave file or MP3 file (or any other audio format) to the subscriber or subscriber computer device, respectively.

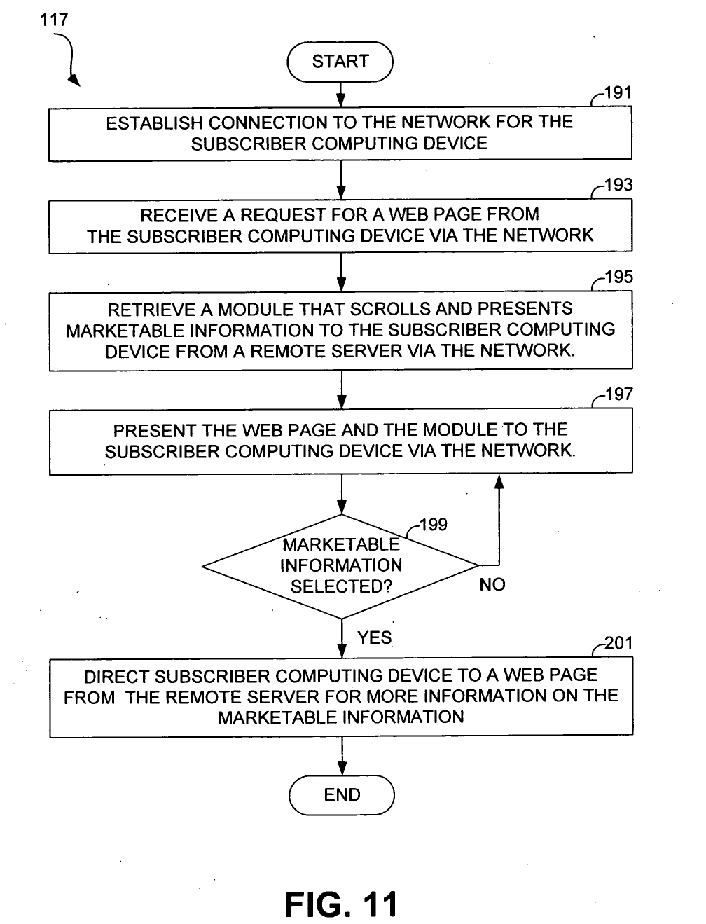

FIG. 11 is a flow diagram that illustrates an embodiment of operation of a network provider manager of the network provider server that is shown in FIG. 6. In block 191, the network provider manager 117 establishes connection to the network 9 for the subscriber computing device 5. In block 193, the network provider manager 117 receives a request for a web page from the subscriber computing device 5 via the network 9. In block 195, the network provider manager 117 retrieve a module that presents marketable information to the subscriber computing device 5 from a remote server 4 via the network 9. In block 197, the network provider manager 117 presents the web page and a module that scrolls and presents the marketable information to the subscriber computing device 5 via the network 9.

In block 199, the network provider manager 117 determines whether the subscriber selected an identification of the marketable information from the module. If an identification of the marketable information was not selected, the module continues to scroll and present the identifications of the marketable information on the web page. If an identification of the marketable information was selected, the network provider manager 117, as indicated in block 201, directs the subscriber computing device 5 to a web page from a remote server 4, such as a photo storage application server 3 or a third party server 11. In the example involving the photo storage application server 3, the photo server manager 97 communicates with the subscriber computing device 5 preferably starting at block 169 of FIG. 10.

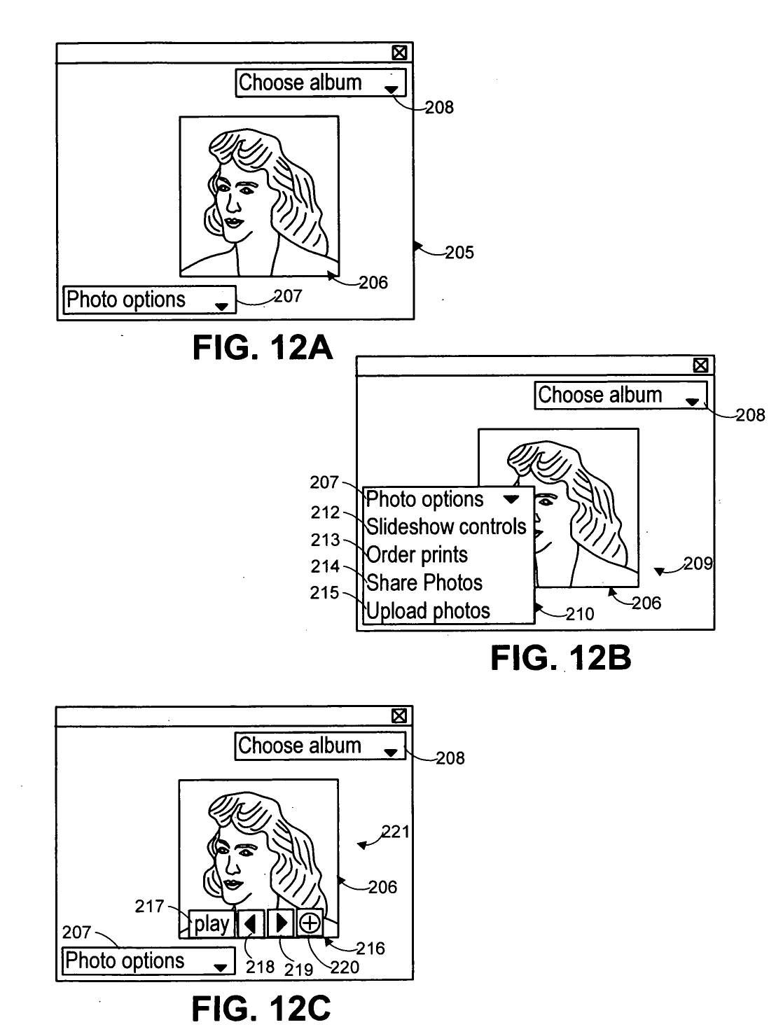

FIGS. 12A-C show an exemplary sequence of screen captures of one example of a module for scrolling photographs. In FIG. 12A, the screen 205 includes a portion 206 where the photographs scroll when the user visits the web page. The screen 205 provides a “Photo options” control 207 that allows users to choose options for the current photograph and photo album being presented. The screen 205 also provides a “Choose album” control 208 that allows users to choose a different photo album so that photos from the selected photo album may scroll in the portion 206.

FIG. 12B shows a screen 209 that includes a menu 210 that is generated upon selection of the control 207. Within this menu 210, there is a “Slideshow controls” option 212, an “Order prints” option 213, a “Share photos” option 214, and an “Upload photos” option 215. The user may select the option 212 to take control of the scrolling photos in portion 206. Discussion of the available controls is provided below in relation to FIG. 12C. The user may select the option 213 to order prints of the current photograph or other photographs of the current album or another album selected by control 208. The user may select the option 214 to share the current photograph or other photographs of the current album or another album selected by control 208 such as by having those photographs or a link to those photographs emailed to a list of recipients. The user may also select the option 215 to upload new photos to the current album or another album selected by control 208.

FIG. 12C shows a screen 221 that includes a control bar 216 that is displayed in response to the user selecting the option 212 of FIG. 12B in order for the user to take control of the scrolling photographs of the portion 206. In this example, the control bar includes a play button 217 to cause the slideshow to start, a reverse button 218 to move backward through the photographs of the current album, a forward button 219 to move forward through the photographs of the current album, and a zoom button 220 that allows the user to zoom in and out for the current photograph. Via the control bar 216, the user is given the ability to find photographs by manually scrolling backward or forward, the ability to examine details of the photograph via the zoom feature, and the ability to resume the slideshow via the play option after having moved backward, forward, or having used the zoom feature.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, having thus described the disclosure, at least the following is claimed:

1. A device for presenting marketable information, comprising:
a network connection for accessing web pages;
a display for displaying the web pages;
a user input device for making selections from the web pages being displayed; and
a processor that implements instructions to access the web pages via the network connection, display the web pages on the display, receive the user input and send corresponding signals via the network connection, wherein at least one of the web pages is based on an identity of the particular user accessing the web page and includes an area for scrolling marketable information corresponding to the identity of the user upon the web page initially being displayed.

2. The device of claim 1, wherein the marketable information comprises photographs.

3. The device of claim 2, wherein the photographs comprise photographs uploaded to the web page by the user.

4. The device of claim 2, wherein the processor receives user input to purchase a print of at least one of the photographs scrolling on the web page.

5. The device of claim 1, wherein the marketable information comprises at least one of audio files, video files, and on-line game clips, and wherein the processor receives user input to purchase a CD for the audio files, DVD for the video files, and game cartridges from the on-line game clips.

6. A method for presenting marketable information stored in a database of a remote server, comprising:
providing a web page associated with an identity of a requesting user via a network connection;
including a module in the web page that scrolls marketable information associated with the identity of the user from a database;
receiving a request and information to purchase an item associated with the marketable information that was presented by the module in the web page; and
processing the request and information to purchase the requested item associated with the marketable information.

7. The method of claim 6, wherein the marketable information comprises photographs and wherein providing the web page is performed by a photo storage application server, wherein the photographs from the photo database are stored in the photo storage application server.

8. The method of claim 7, wherein scrolling the photographs comprises presenting a slideshow of the photographs by the module.

9. The method of claim 8, wherein providing the web page to a subscriber computing device further comprises providing the web page by way of a network provider server that receives the photographs from the photo database of a photo storage application server.

10. The method of claim 6, wherein the marketable information comprises audio files, video files, and on-line game clips.

11. The method of claim 10, further comprising providing a request and information to purchase the audio files, video files, and on-line game clips that were presented by the module in the web page, and processing the request and information to purchase CDs for the audio files, DVDs from the video files, and game cartridges from the on-line game clips.

12. A computer readable medium having a computer program for presenting marketable information, the program comprising:
logic for receiving a web page via a network connection including a module in the web page that displays marketable information from a database wherein the marketable information corresponds to an identity of a user requesting the web page;
logic for scrolling the display of the marketable information in the module;
logic for receiving a request and information to purchase an item corresponding to the marketable information that was presented by the module in the web page; and
logic for submitting the request and information via the network connection.

13. The computer readable medium of claim 12, wherein the marketable information comprises photographs.

14. The computer readable medium of claim 13, wherein the logic for scrolling the photographs in the module comprises presenting a slideshow of the photographs by the module.

15. The computer readable medium of claim 12, wherein the marketable information further comprises at least one of audio files, video files, and on-line game clips.
